(19) United States
(12) Patent Application Publication
(10) Pub. No.: US 2005/0173225 A1
(43) Pub. Date: Aug. 11, 2005

(54) Conveyor

(75) Inventors: Andrew John Harwood, Christchurch (NZ); Bruce Hyndman Henley, Invercargill (NZ)

Correspondence Address: MCCORMICK, PAULDING & HUBER LLP, CITY PLACE II, 185 ASYLUM STREET, HARTFORD, CT, 06103, US

(73) Assignee: Henley Industries Limited c/o Ward Adams Bryan-Lamb, Invercargill (NZ)

(21) Appl. No.: 10/516,397

(22) PCT Filed: Jun. 4, 2003
(86) PCT No.: PCT/NZ03/00110

(30) Foreign Application Priority Data
Jun. 5, 2002 (NZ) 519386

(51) Int. Cl. B65G 47/28

(52) U.S. Cl. 198/458

(57) ABSTRACT

A conveyor (2) which is able to reposition articles (15) or to alter spacing of articles carried on the conveyor (5), the conveyor having a pair of spaced parallel drive means (3,4) between which are secured a number of spaced parallel rigid supports (10) which when moved by the drive means are arranged to follow guide tracks (6,7) arranged between the drive means (3,4), the guide tracks being arranged to converge or diverged as required; each support has a pair of spaced retainer blocks (8,8) mounted on it and a coil spring (9) is mounted around each support between each pair of retainer blocks; the coil spring expands or contacts as the spacing between the retainer blocks increases or decreases.

### TECHNICAL FIELD

The present invention relates to a conveyor, and in particular to a conveyor which is capable of altering the position of articles on a conveyor or the spacing between articles supported in a row across the width of the conveyor, i.e. perpendicular to the direction of movement of the conveyor.

A standard conveyor simply moves articles placed on the conveyor from one location to another, with the articles remaining at the same position/spacing. In general, if the position or spacing of the articles has to be altered for manufacturing purposes, then the articles on the conveyor are thinned out or reoriented by moving them relative to the conveyor; in general, this is performed manually.

### BACKGROUND ART

One known design of conveyor which is capable of re spacing articles comprises a conveyor surface made up of a series of polyurethane cords arranged in a fan shaped configuration with the length of each cord aligned with the direction of movement of the conveyor. The cords are moved by individual driving bobbins, mounted on a pair of spaced curved axles, one axle at each end of the “fan”. However, this type of conveyor has proved unsuitable for use with greasy or oily products (for example some food stuffs) because the cords are driven by a friction drive and have a tendency to slip:—any additional oil or grease on the cords makes this problem much worse. Further, this type of conveyor is difficult to clean.

### DISCLOSURE OF INVENTION

It is an object of the present invention to provide a conveyor which is capable of repositioning or re spacing articles carried on the conveyor which overcomes the above described problems.

The conveyor of the present invention has been designed with especial reference to the problem of conveying strips or fingers of food stuffs which have been cut from a solid block and deposited straight onto the conveyor to be moved for further processing. Since the fingers have been cut from a solid block, they are deposited onto the conveyor with all the fingers touching each other, and the fingers need to be spaced apart for further processing to take place. However, it will be appreciated that the conveyor of the present invention is suitable for a wide range of applications where articles supported by the conveyor need to be spaced further apart or moved closer together. Further, the conveyor of the present invention can be used to reposition articles, and in particular to “singulise” articles, i.e. to reposition an article placed on a conveyor such that an article can be placed anywhere across the width of the conveyor but can be repositioned by one or more conveyors, so that the article on reaching the end of the conveyor or the end of a series of such conveyors, is in a predetermined position on the conveyor, e.g. in the centre of the conveyor.

The present invention provides a conveyor which includes: a pair of spaced parallel drive means arranged one each side of the path of the conveyor; a plurality of spaced parallel rigid supports secured between said drive means with the longitudinal axis of said supports perpendicular to the path of the conveyor; a pair of guide tracks arranged between said drive means, said guide tracks being arranged to converge or diverge from a first predetermined spacing at one portion of said guide tracks to a second predetermined spacing at another predetermined portion of said guide tracks; each support having a pair of spaced retainer blocks mounted thereon, with one block of each pair being engaged with one of said guide tracks and the other block of each pair being engaged with the other of said guide tracks; and a coil spring mounted around each support between each pair of retainer blocks and engaged with the retainer blocks such that the coil spring expands or contracts in length as the spacing between the retainer blocks increases or decreases.

The coil springs may be made of any suitable material (e.g. stainless steel, plastics) and may be tension springs or compression springs. If the coil springs are tension springs, then the guide tracks preferably provide channels for engagement with the retainer blocks, to elongate the coil springs as the guide tracks diverge.

If the coil springs are compression springs, then it may be acceptable for the ends of the compression springs to engage the retainer blocks simply by compressive engagement, although if a large degree of extension of a compression spring is required it has been found preferable to provide a positive engagement between each spring and the corresponding block, e.g. a screw thread connection.

Further, if the coil springs are compression springs, the guide tracks may be simply a flat surface against which the retainer block is pressed by the force of the compression spring. However, if a large degree of extension of a compression spring is required it has been found preferable to use guide tracks which provide a channel for engagement with the retainer blocks, at least over that part of the length of the guide tracks where the divergence between the tracks is greater.

### BRIEF DESCRIPTION OF THE DRAWINGS

By example only, a preferred embodiment of the present invention is described in detail, with reference to the accompanying drawings in which:—

FIG. 1 is a diagrammatic plan view of a first embodiment of a conveyor in accordance with the present invention;

FIG. 2 is a section on line II-II of FIG. 1;

FIG. 3 is an exploded plan view of a detail of FIG. 1;

FIG. 4 is a side view of FIG. 3, with the components fully assembled;

FIG. 5 is an exploded plan view equivalent to FIG. 3, but of a second embodiment of the invention;

FIG. 6 is a side view of FIG. 5, with components fully assembled;

FIG. 7 is a diagrammatic plan view of a third embodiment of a conveyor in accordance with the present invention;

FIG. 8 is a section on line VIII-VIII of FIG. 7;

FIG. 9 is a plan view of a detail of FIG. 7; and

FIG. 10, is a side view of FIG. 9.

### BEST MODE FOR CARRYING OUT THE INVENTION

Referring to the drawings a conveyor 2 includes two spaced parallel drive chains 3,4 of known type which are arranged to support and drive a conveyor bed 5 located between the drive chains. The conveyor 2 is supported above the ground or floor by any suitable type of support (not shown). The conveyor bed 5 normally would be positioned symmetrically between the drive chains, but could be positioned as asymmetrically if necessary.

The drive chains 3,4 are located one down each side of the path of the conveyor. Each drive chain may be of any suitable type, for example, a continuous length of hollow pin chain driven by drive sprockets at one or both ends of each run of chain, one or both drive sprockets being rotated by an electric motor.

The conveyor bed 5 is positioned symmetrically between the drive chains 3,4 and consists of two guide tracks 6,7 which support a plurality of retainer blocks 8 arranged in opposed pairs, each pair of retainer blocks 8 supporting a pair of coil springs 9,9a, as described with reference to FIGS. 3-5.

Each retainer block 8 is rectangular in plan and square in cross-section. Each block 8 is formed with a pair of spaced through holes 8a, each of which passes right through the width of the block. Each hole 8a receives a stainless steel rod 10 which has a length greater equal to the distance between the drive chains 3,4.

Each rod 10 is secured at one end to the drive chain 3, passes through the hole 8a of one retainer block 8, extends across the width of the conveyor bed 5, passes through the hole 8a of the other retainer block 8 of that pair, and is secured at the other end to the drive chain 4.

The pairs of retainer blocks 8 are arranged with one of the blocks of each pair engaged with the guide track 6, and the other block of each pair engaged with the guide track 7. A pair of parallel coil springs 9 extend between each pair of blocks 8, around the corresponding rods 10.

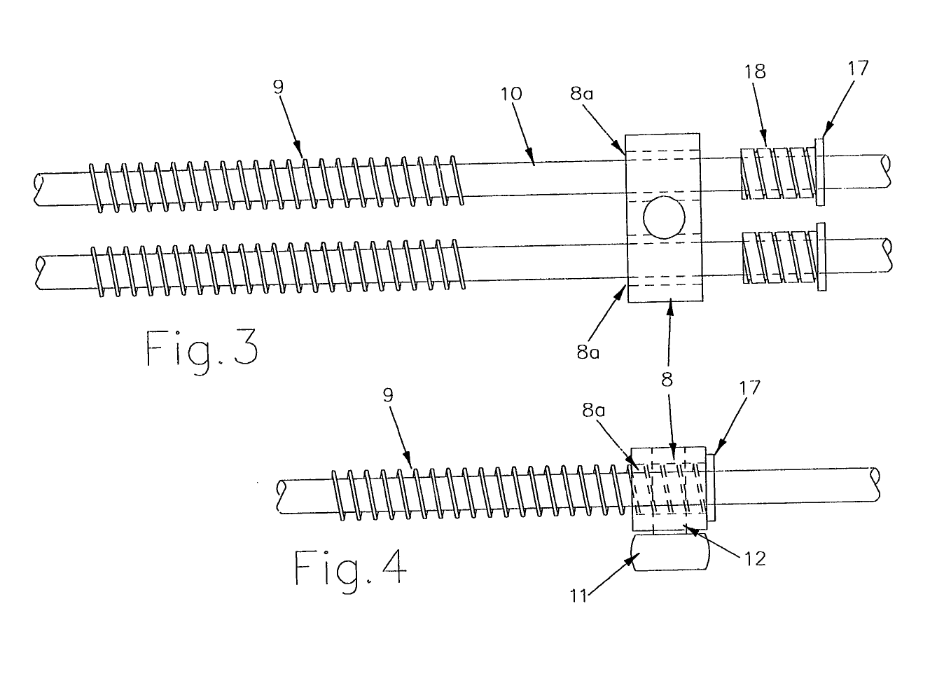

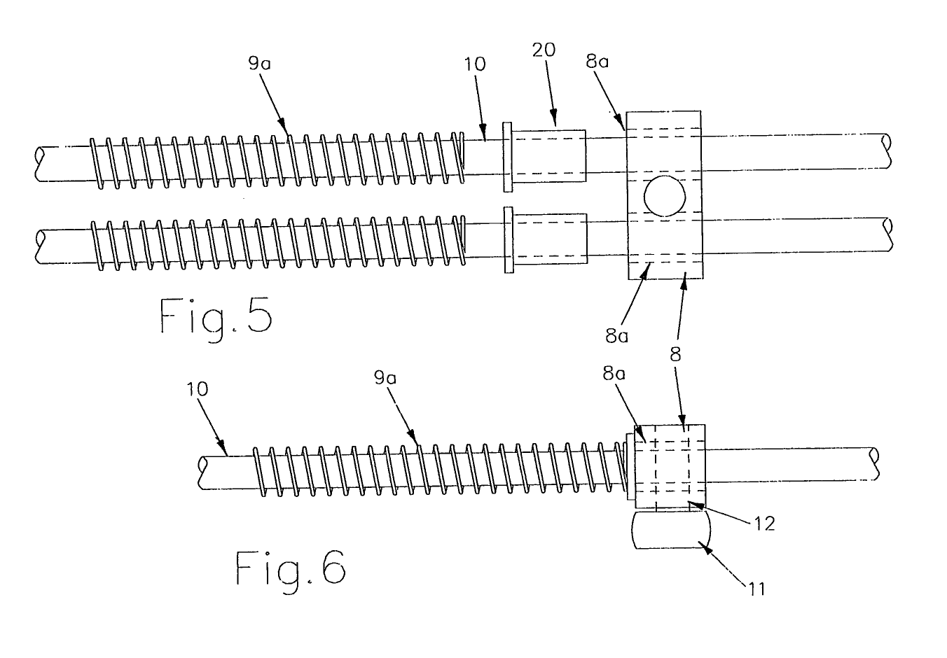

As shown in FIGS. 4 and 6, each retainer block 8 carries a guide roller 11 mounted below the block on an axle 12 which is substantially perpendicular to the plane of the corresponding block.

FIGS. 3 and 4 show one arrangement of the coil springs, in which the coil springs 9 are stainless steel tension springs. In this embodiment, each end of the spring 9 is anchored within the hole 8a in the retainer block 8 by means of a retainer bush 17 which incorporates a screw retainer 18. The screw retainer 18 provides a screw of the same pitch as the spring 9, with the retainer 18 being sized to allow the spring 9 to be screw-threadedly engaged with the internal screw thread on the retainer 18. To secure each end of the spring 9 to the corresponding retainer block 8, the bush 17 is mounted onto the rod 10 on the opposite side of the retainer block 8 to the coil spring 9, and push-fitted into the hole 8a. The bush 17 is an interference fit in the hole 8a and when in position engages the axle 12 to lock the axle 12 and roller 11 to the block 8. One end of the coil spring 9 is then screwed into the screw retainer 18. Each end of each coil spring 9 is secured in the same way.

A second arrangement is illustrated in FIGS. 5 and 6. In this variant, a plastics compression coil spring 9a is used in place of the spring 9. Since the spring 9a is a compression spring, it is dimensioned so that it is fully compressed when the conveyor bed is at its narrowest (A), and expanded when the conveyor bed is at its widest (B). Because the spring 9a is in compression, it does not need to be secured to the retainer blocks 8:—each end of each spring 9a simply butts up against a bush 20 which slides over the rod 10 and is press fitted into the hole 8a in the corresponding block 8. The bush 20 locks the axle 12 and roller 11 to the block 8 when fitted into the hole 8a.

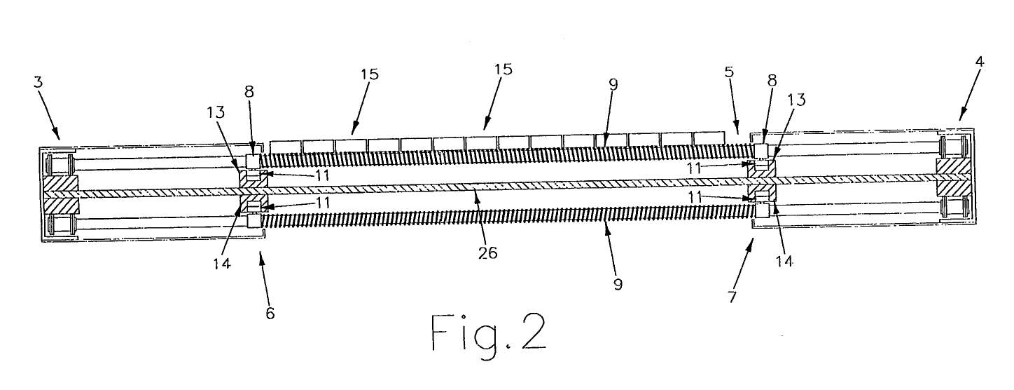

Each guide track 6,7 provides two U-cross-section channels 13,14 (FIG. 2) each of which is dimensioned and arranged to receive the guide rollers 11 of the retainer blocks 8. The channels 13,14 are arranged back-to-back:—the channel 13 carries the guide rollers of the retainer blocks for the upper run of the conveyor, and the channel 14 carries the guide rollers of the retainer blocks for the return run of the conveyor.

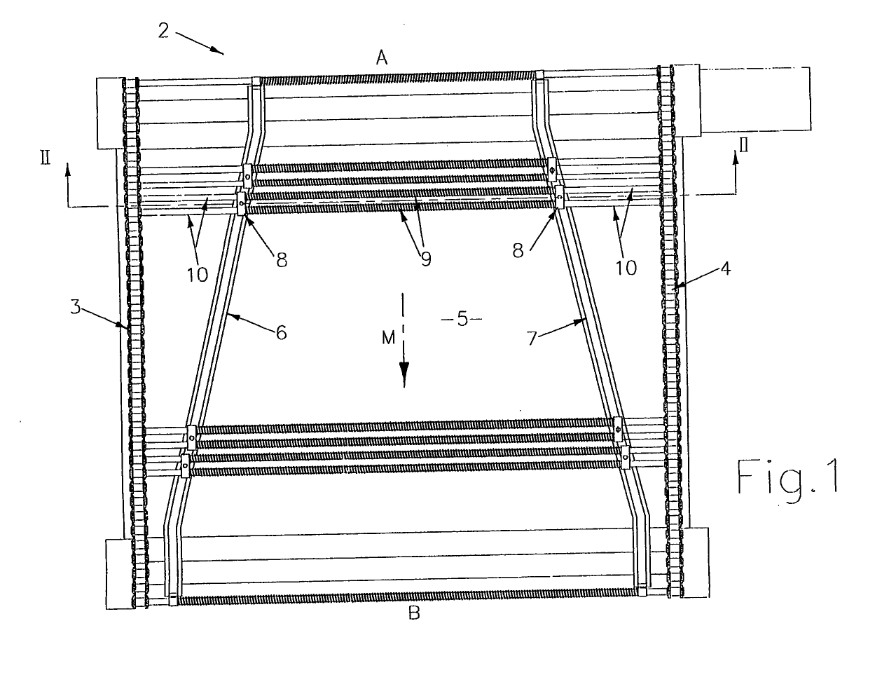

The guide tracks 6,7 diverge from each other so that the width of the conveyor at the end of the run B is substantially wider than the width of the conveyor at the start of the run A, assuming that the conveyor is moving in the direction of Arrow M. The degree of divergence may be altered to suit particular applications; in the particular example illustrated in FIG. 1, the effective width of the conveyor at the start A is 500 mm and the effective width of the conveyor at the end B is 750 mm.

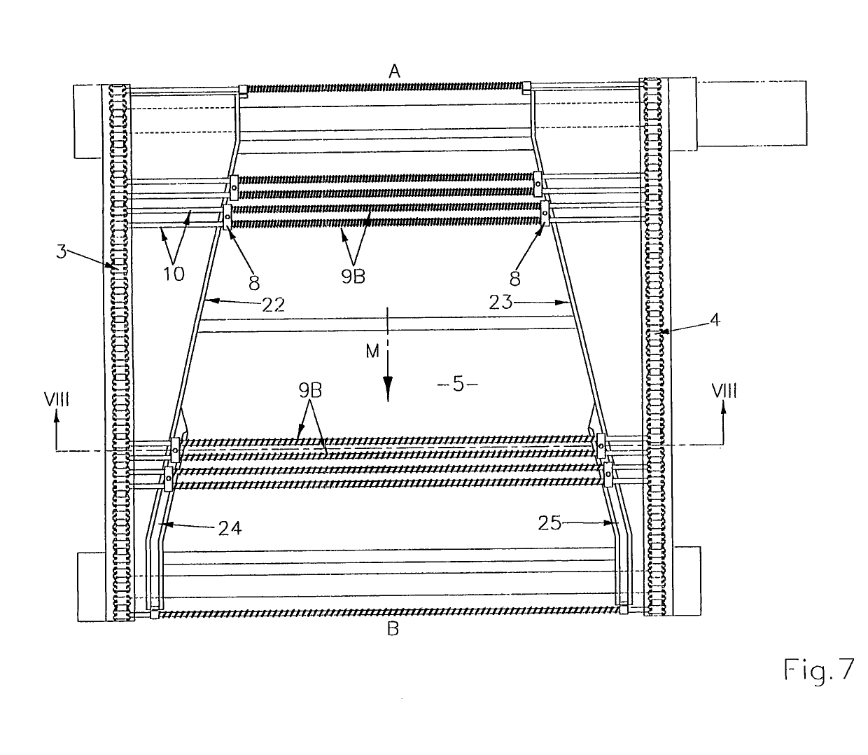

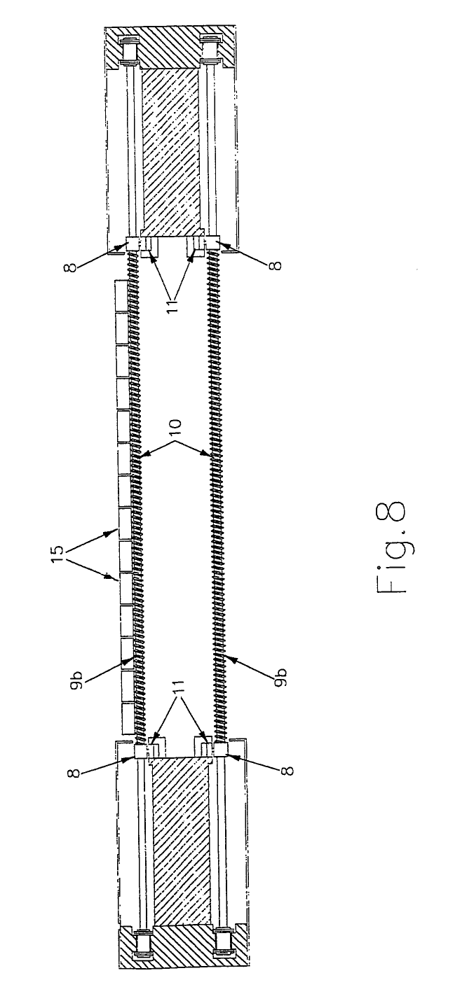

A third embodiment of the invention is shown in FIGS. 7-10. In this embodiment, the features of the conveyor are the same as those described with reference to FIGS. 1-6 unless otherwise specified, and the same reference numerals are used where appropriate.

In this embodiment, the coil springs 9b are plastics compression coil springs of the type described with reference to FIGS. 5 and 6, but instead of the ends of the coil springs simply butting up against a bush, as in the FIGS. 5 and 6 embodiment, each end of each spring is secured to the retainer block 8, as hereinafter described. This modification overcomes a problem encountered using compression coil springs in applications where a large degree of expansion of the spring is required towards end B of the conveyor:—the coil springs may fail to expand to the degree required, especially if the springs are kept in a fully compressed condition for long periods.

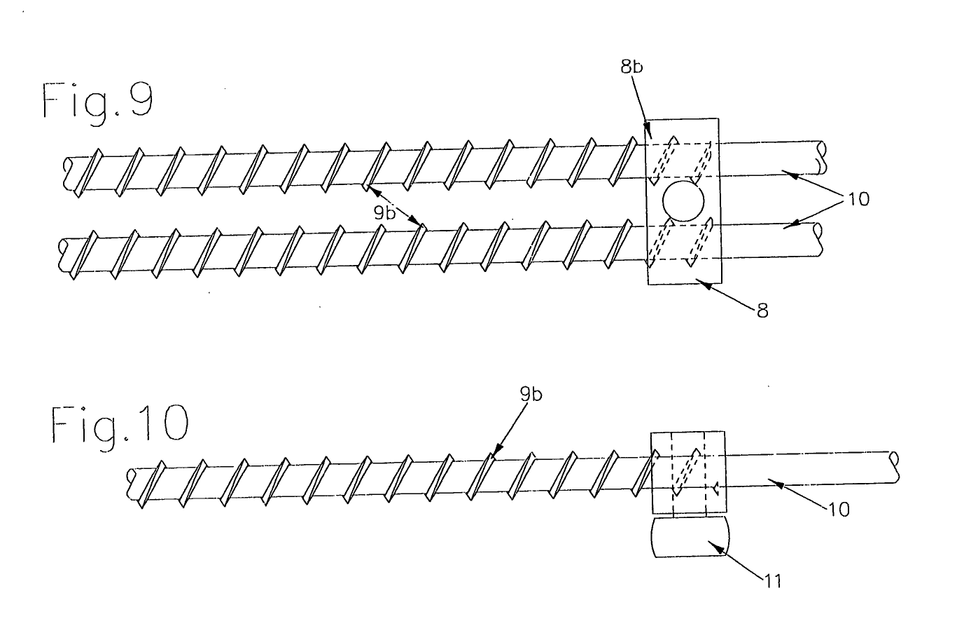

As shown in detail in FIGS. 9 and 10, each end of each coil spring 9b is positively anchored in the corresponding retainer block 8 by forming the interior bore 8b of the block with a helical screw thread, and screwing each end of each coil spring 9b into the corresponding bore, to secure the coil spring to the retainer block. Preferably, each spring is engaged with the corresponding bore with a 360 degree preload so that the spring is positively retained in the bore by torsional energy.

Each retainer block 8 provides two parallel interior bores 8b. Each retainer block 8 supports a guide roller 11, as in the above described embodiments.

The guide tracks 22,23 do not provide a U-cross-section channel over the whole of their length, like the guide tracks 6,7 in the first embodiment. Instead, the guide tracks 22,23 provide a U-cross-section channel 24,25 only over approximately the widest one-third of the length of the track, i.e. the portion of the track as it approaches the widest end B of the conveyor. For the remainder of each guide tracks 22,23, the track is formed simply from a smooth surface against which the guide roller 11 of each retainer block 8 travels, with each guide roller held into engagement with the track by the force of the compression spring 9b.

However, as the guide tracks 22,23 approach their widest separation, the force of the compression springs 9b may be insufficient to keep the corresponding roller in engagement against the side of the track, and this portion of each track therefore is formed as a U-cross-section channel 24,25 in which the guide rollers 11 engage in the same manner as described with reference to the channels 13 in FIG. 1.

This embodiment of the conveyor is particularly easy to dismantle for cleaning, since the springs 9b can be quickly and easily unscrewed from the retainer blocks 8, and the major portion of the length of the guide tracks 22,23 is simply a flat surface which is very easy to clean.

The above described conveyors are used as follows:—the conveyor 2 is to be used to carry narrow slices 15 of frozen fish from start position A to end position B. At start position A, a large block of frozen fish is sliced into slices 15 using a saw or similar known means, and the slices 15 are allowed to fall onto the conveyor, with the length of each slice parallel to the direction of movement M of the conveyor. Because the slices 15 have been cut from a large block and fall directly onto the conveyor, they lie very close to each other, possibly even touching each other. For further processing (in this case battering and crumbing to form fish fingers) the slices 15 must be separated.

The conveyor 2 is moved by the rotation of the drive chains 3,4:—each pair of retainer blocks 8 is secured to the adjacent drive chains 3/4 by the rods 10, so that movement of the drive chains 3,4 slides the retainer blocks 8 along the channels 13 in the guide tracks 6,7 (FIG. 1) or along the tracks 22,23 (FIG. 7).

As the tracks 6,7/22,23 diverge, the springs 9,9a,9b secured between the pairs of retainer blocks 8 extend to accommodate the increased width of the conveyor.

As the springs 9,9a,9b gradually extend, the slices 15 of fish carried on the springs are spaced further and further apart, until by the time the end B of the conveyor is reached, the slices 15 are at the desired spacing for further processing. At the end B, the slices 15 are removed from the conveyor for further processing, and the springs 9,9a,9b retainer blocks 8 and rods 10 travel onto the return (i.e. lower) run of the conveyor.

It will be appreciated that the above described conveyor could be run in the opposite direction if it was required to converge product carried on the conveyor rather than diverge it. Further, the conveyor can be arranged to converge and diverge product more than once over the length of the run of the conveyor:—it is simply a matter of arranging the shape of the guide tracks to provide the required changes in spacing. Thus, if it is required, e.g. initially to diverge product deposited on the conveyor in a block, and then to converge it back together again once it has been processed in some way, the guide tracks can be shaped to provide this.

In addition, as described above, one or more conveyors of the above described type can be arranged to “singulise” articles.

The conveyor is secured together by a series of spaced tie rods 26 (FIG. 2 only) which extend parallel to the rods 10 and are positioned between the upper and lower runs of the conveyor. Advantageously, some or all of the tie rods could be formed as air-knives or as a water-spray (sparge) line, for cleaning the conveyor.

A removable tray may be mounted beneath the conveyor, to catch crumbs and broken or fallen product.

1. A conveyor which includes: a pair of spaced parallel drive means arranged one each side of the path of the conveyor; a plurality of spaced parallel rigid supports secured between said drive means with the longitudinal axis of said supports perpendicular to the path of the conveyor; a pair of guide tracks arranged between said drive means, said guide tracks being arranged to converge or diverge from a first predetermined spacing at one portion of said guide tracks to a second predetermined spacing at another predetermined portion of said guide tracks; each support having a pair of spaced retainer blocks mounted thereon, with one block of each pair being engaged with one of said guide tracks and the other block of each pair being engaged with the other of said guide tracks; and a coil spring mounted around each support between each pair of retainer blocks and engaged with the retainer blocks such that the coil spring expands or contracts in length as the spacing between the retainer blocks increases or decreases.

2. The conveyor as claimed in claim 1, wherein each said drive means includes a drive chain.

3. The conveyor as claimed in claim 1, wherein each retainer block is formed with a through hole through which the corresponding end of the associated support is arranged to pass.

4. The conveyor as claimed in claim 3, wherein each retainer block includes a guide roller arranged to engage the adjacent guide track.

5. The conveyor as claimed in claim 1, wherein each guide track provides a U-cross-section channel adapted to engage each corresponding retainer block.

6. The conveyor as claimed in claim 1, wherein each guide track is formed as a flat abutment face for a first part of its length, and for the remainder of its length provides a U-cross-section channel adapted to engage each corresponding retainer block; said remainder of the length of each guide track comprising that portion of the length of said guide track over which the guide tracks are further apart compared to said first part.

7. The conveyor as claimed in claim 1, wherein each said coil spring is a tension spring.

8. The conveyor as claimed in claim 7, wherein each said coil spring is engaged with the corresponding retainer block by means of a retainer bush engaged with a hole in said retainer block through which the end of the corresponding support passes.

9. The conveyor as claimed in claim 1, wherein each said coil spring is a compression spring.

10. The conveyor as claimed in claim 9, wherein each said coil spring is engaged with the corresponding retainer block by means of a compression engagement between the end of said spring and said block.

11. The conveyor as claimed in claim 6, wherein each said coil spring is a compression spring.

12. The conveyor as claimed in claim 11, wherein each said coil spring is screw threadedly engaged with the corresponding retainer block.

13. (canceled)

14. (canceled)

15. The conveyor as claimed in claim 1, wherein said conveyor is secured together by a series of spaced tie rods which extend parallel to said supports and are arranged between the upper and lower runs of the conveyor, and one or more of said tie rods is selected from the group consisting of: an air knife; a water sprayer.

16. (canceled)

17. (canceled)

18. The conveyor as claimed in claim 1, wherein said conveyor over its path provides a single convergence or divergence.

19. The conveyor as claimed in claim 1, wherein said conveyor over its path provides two or more convergences and/or divergences.

20. (canceled)
